(19) United States
(12) Patent Application Publication
(10) Pub. No.: US 2012/0186833 A1
(43) Pub. Date: Jul. 26, 2012

(54) FLAME RESISTANT FIBERGLASS INSULATION, PRODUCTS, AND METHODS

(75) Inventors: Paul D. Wlodarczyk, Indianapolis, IN (US); Ronald A Houpt, Shelbyville, IN (US); Curtis Davies, Shelbyville, IN (US); Steven Lee Collings, Shelbyville, IN (US)

(73) Assignee: KNAUF INSULATION GMBH, Shelbyville, IN (US)

(21) Appl. No.: 13/388,346

(22) PCT Filed: Aug. 4, 2010
(86) PCT No.: PCT/US10/44330

§ 371 Date: Apr. 16, 2012

Related U.S. Application Data
(60) Provisional application No. 61/231,183, filed on Aug. 4, 2009.

(51) Int. Cl. A62C 3/00; D04H 3/12; F16L 9/14

(52) U.S. Cl. 169/45; 138/149; 442/414

(57) ABSTRACT

Provided are fiberglass insulations which have a softening point of less than, or no more than, 699° C., and an elevated glass viscosity at the UL 181 test temperature of 774° C. Also provided are insulated products, such as ducts, which have the fiberglass insulations thereon, as well as methods of improving the flame penetration resistance of an insulated product.

### CROSS-REFERENCE TO RELATED U.S. PATENT APPLICATIONS

This application claims priority under 35 U.S.C. §119(e) to U.S. Provisional Application Ser. No. 61/231,183 filed Aug. 4, 2009, the entirety of which is hereby incorporated herein by reference.

### BACKGROUND

Various types of insulated flexible ducts are known for use in heating and air conditioning applications. Because the flexible ducts are employed in buildings, the ducts are subject to local building codes and regulations. To comply with building codes and receive a UL rating, flexible air ducts must pass a UL 181 Standard. This standard includes many requirements relating, e.g., to strength, corrosion, mold growth and burning characteristics. The requirement of interest in the present invention is a flame penetration requirement. Current flexible ducts do not always pass the flame penetration test of the UL 181 Standard. Passing the flame penetration test is particularly an issue for flexible ducts containing a relatively thin layer of insulation, e.g., an insulation layer having an R value of 0.74 m2-K/W.

Efforts have been made to improve the flame resistance of insulated flexible ducts. For example, U.S. Pat. No. 5,526,849 describes a flexible duct including a flame resistant yarn helix disposed between the inner and outer walls of the duct. This structure requires additional material and cost. U.S. Pat. No. 4,410,014 describes a flexible duct including a glass fiber scrim laminated to the insulation to improve the flame resistance of the duct. Drastically increasing the weight of the scrim greatly increases the probability of passing the flame penetration test, but at an unacceptable cost. U.S. Pat. No. 6,527,014 describes insulated ducts which have a softening point of at least 699° C.

Thus, it is desirable to provide fiberglass insulations, fiberglass insulation products, and methods for producing fiberglass insulation having improved characteristics including flame resistance.

Provided are fiberglass insulations which have a softening point of less than, or no more than, 699° C., and an elevated glass viscosity at the UL 181 test temperature of 774° C. Also provided are insulated products, such as ducts, which have the fiberglass insulations thereon, as well as methods of improving the flame penetration resistance of an insulated product.

The flame resistant fiberglass insulation of the invention comprises a network of intertwined fibers of glass. Fiberglass insulation is well known and has been a commercial product for an extended period of time. The insulation product may be formed from fibrous glass wool, for example.

The flame resistant fiberglass insulation may be made from glass fibers that have been fiberized by a rotary process. In the rotary process, molten glass material is introduced into a spinner having a plurality of fiber-forming orifices in its peripheral wall. Rotation of the spinner causes the molten material to flow by centrifugal force through the orifices and form fibers. The fibers flow down from the spinner and are collected. The fibers are usually coated with a binder as they flow down from the spinner. A conveyor typically collects the binder-coated fibers in the form of a blanket, and the blanket is heat cured to produce the final insulation product. Insulation materials of various densities can be produced by varying the conveyor speed and the thickness of the cured insulation. Preferably, the insulation product is fibrous glass wool having a density within a range of from about 8 kg/m3 to about 48 kg/m3.

The softening point is defined as the temperature at which the viscosity of the material is 107.6 poise, as measured according to ASTM C338. Of course this parameter, like any other parameter mentioned in this application, can be measured by any other suitable test. The softening point temperature of the invention is 699° C. or less, preferably about 695° C. or less, and most preferably about 686° C. or less. The range of the softening point is between about 680-699° C., and more desirably 685-695° C.

The log 3 temperature is the temperature at which the fiberglass has a viscosity of 1,000 poise (roughly the fiberizing viscosity), where the viscosity is determined by conventional means, such as by measuring the torque needed to rotate a cylinder immersed in the molten material, according to ASTM Method C 965. Preferably, the material has a log 3 temperature of greater than or equal to about 1050° C., and more preferably greater than about 1080° C., and above 1088° C. The range for the log 3 temperature is between about 1050-1090° C.

The liquidus temperature of the material is the temperature below which the first crystal appears in the molten material when it is held at that temperature for 16 hours, according to ASTM Method C 829. The range for the liquidus temperature is between about 850-900° C., and more desirably 850-860° C.

The difference between the log 3 temperature and the liquidus temperature is called delta T. Preferably, the delta T is at least about 150° C., more preferably at least about 175° C., and most preferably above 200° C.

Elevated glass viscosity is calculated at 774° C. for the target oxide content of the glass using the model developed by A. Fluegel (“Glass viscosity calculation based on a global statistical modeling approach” Alexander Fluegel, Glass Technol.: Europ. J. Glass Sci. Technol. A, vol. 48, 2007, no. 1, p 13-30). UL181 test results of average failure times are plotted against the calculated log 10 viscosities. Standard glass compositions with log 10 viscosities of 5.6 to 6.0 poise yield failure times of 12 to 16 minutes. Failure time increase was predicted to be 6 to 8 minutes in the model with 774° C. log 10 viscosities between 6.1 and 6.3 poise. Actual material failure times increased 4 to 17 minutes with the invention glass composition.

It has been determined the goal of having a fiberglass insulation with the desired elevated glass viscosity and softening point temperature could be obtained by lowering the alumina and boric oxide content of the glass formulation. The ranges for the alumina and boric oxide is between about 6.1 to about 8.5 wt. %, desirably less than about 7 wt. %. Individually, the alumina may be present in the amount of between about 1.25 to about 2.5 wt. %, and the boric acid may be present in the amount of between about 4.85 to about 6.00 wt. %. Also, the calcium to magnesium ratio (wt. %/wt. %) can be increased to facilitate higher external cullet content and lower melt temperatures, with the ratio in the range of between about 3.0 to about 4.0, and preferably about 3.4.

The total alkali content, that being the amounts of sodium and potassium oxides present in the fiberglass, is present above about 15 wt. %, and is in the range of about 15 to about 16.5 wt. %.

The examples of fiberglass compositions are illustrative and the invention is not limited to them.

### EXAMPLE 1

| Component | Wt. % |
|---|---|
| SiO₂ | 63.93 |
| Al₂O3 | 2.50 |
| CaO | 8.51 |
| MgO | 2.75 |
| Na₂O | 15.56 |
| K₂O | 0.57 |
| B₂O₃ | 6.00 |
| Fe₂O₃ | 1.42 |
| SO₃ | 0.036 |

### EXAMPLE 2

| Component | Wt. % |
|---|---|
| SiO₂ | 66.79 |
| Al₂O3 | 1.9 |
| CaO | 8.00 |
| MgO | 2.5 |
| Na₂O | 15.19 |
| K₂O | 0.45 |
| B₂O₃ | 5.00 |
| Fe₂O₃ | 0.138 |
| SO₃ | 0.038 |

### EXAMPLE 3

| Component | Wt. % |
|---|---|
| SiO₂ | 68.81 |
| Al₂O3 | 1.25 |
| CaO | 7.5 |
| MgO | 2.22 |
| Na₂O | 14.88 |
| K₂O | 0.32 |
| B₂O₃ | 4.85 |
| Fe₂O₃ | 0.132 |
| SO₃ | 0.039 |

The properties of the examples follows in Table 1.

TABLE 1

| | | Estimated | | Liquidus | Melt Tem- | |
|---|---|---|---|---|---|---|
| | Est Log 3 | softening | | Temper- | perature | |
| | Viscosity | point | Est | ature | (° C.)/ | Cullet |
| | (° C.) | (° C.) | Kdis | (° C.) | (° F.) | % |
| Example | 1050 | 681 | 249 | 895 | 1322/2412 | 40.00 |
| 1 | | | | | | |
| Example | 1073 | 683 | 161 | 877 | 1377/2511 | 43.00 |
| 2 | | | | | | |
| Example | 1088.1 | 685.5 | 146.2 | 857.3 | 1403/2557 | 45.00 |
| 3 | | | | | | |

The present invention also retains the ability of the mineral material to produce an acceptable insulation product. For example, the insulating ability of the material is kept at an acceptable level. The insulating ability can be measured as the thermal conductivity, k, of the fibrous mineral material. The lower the thermal conductivity, the better the insulating ability. Preferably, the fibrous mineral material has a thermal conductivity of not greater than about 0.043 W/m° K, and more preferably not greater than about 0.041 W/m° K. The thermal conductivity may be measured on a sample of the fibrous material having a density of 10.97 kg/m³ and a thickness of 0.0381 m.

An insulated product according to the invention is an object having the fiberglass insulation on it, and includes an insulated duct which has a wall or walls defining a hollow interior for conducting a fluid such as heated or cooled air, and a layer of the insulation wrapped about the wall or walls to insulate the transported fluid. Preferably the wall is tubular. The insulated duct can be flexible or non-flexible, depending on the particular application of the duct. In one embodiment, the tubular wall is flexible so that the duct is flexible.

In one embodiment of the invention, the insulated duct includes inner and outer flexible walls and an insulation layer between the walls. The flexible, tubular inner wall defines the hollow interior for conducting the fluid. Typically, the inner wall is a cylindrical tube having a diameter within a range of from about 10.2 cm to about 50.8 cm, usually from about 15.2 cm to about 30.5 cm. The insulation layer is wrapped about the inner wall to surround the inner wall. The flexible, tubular outer wall is wrapped about the insulation layer to provide an outer housing that surrounds the insulation layer and the inner wall and retains them in the proper orientation.

The inner and outer walls of the flexible duct can be formed of any suitable flexible material. Some examples of suitable materials include polymeric films made from thermoplastic polymers such as polyester, polyethylene, polyvinyl chloride or polystyrene. If desired, the polymeric film can be a metalized film. Other suitable materials include various fabrics or polymer-coated fabrics. Preferably, the inner wall is formed of a plastic film such as a polyester film, and the outer wall is formed of a plastic film such as a polyethylene film.

The density and thickness of the layer of insulation product can be varied depending on the fluid to be transported by the flexible duct and the permissible heat transfer rate through the walls of the duct. The layer of insulation product is typically glass fiber insulation having a thickness within a range of from about one inch (2.5 cm) to about three inches (7.5 cm). Preferably, the layer of insulation product is glass fiber wool about 3.8 cm thick before placement in the duct, and about 3.2 cm thick after being compressed between the inner and outer walls of the duct. In one embodiment, the insulation layer has an insulation R value of 0.74 m²-K/W.

The flexible duct usually includes a reinforcing element to provide structural rigidity to the duct. Typically, the reinforcing element is a continuous helically coiled, resilient wire extending along the length of the duct. The reinforcing element can be positioned at various locations in the duct, but typically it is either attached to or encapsulated in the inner wall of the duct. In a preferred embodiment, the reinforcing element is a helically coiled, resilient wire encapsulated in the plastic film of the inner wall. The reinforcing element can be formed of a metallic material such as steel, aluminum, a metal alloy, a plastic material, or a plastic-coated metallic material. Usually, the reinforcing element is formed of a wire spring steel. The diameter of the wire coils is dictated by the size of the duct.

Desirably, the flexible duct also includes a layer of scrim material to provide additional strength and reinforcement to the duct. The layer of scrim material is usually interposed between the outer wall and the layer of insulation. In a desirable embodiment, the layer of scrim material is wrapped about and laminated to the outer surface of the layer of insulation. The scrim material can be any suitable woven or non-woven material. In one embodiment, the scrim uses a G75 yarn having a rectangular pattern or a triangular pattern with a mesh size of about 1.27 cm.

The invention also encompasses methods of improving the flame penetration resistance of an insulated duct, the insulated duct comprising a wall or walls defining a hollow interior for conducting a fluid, and a layer of insulation wrapped about the wall or walls, the method comprising providing the insulation of the invention as described above. The method also includes applying the insulation of the invention to an object such as a duct.

The insulated ducts of the invention has an increased probability of passing the flame penetration test of the UL 181 Standard, specifically Underwriter's Laboratories Inc. 181 Standard for Factory-Made Air Ducts and Air Connectors, Flame Penetration Section, 7th Edition, as revised Nov. 20, 1990. This test is described in detail in U.S. Pat. No. 5,526,849 to Gray, issued Jun. 18, 1996, which is incorporated by reference herein. Briefly, in the flame penetration test, the flexible duct is cut open and flattened, and a 55.9 cm by 55.9 cm sample of the duct is mounted in a frame. The frame is then placed over a flame at 774° C., with the outside face of the duct in contact with the flame. The sample is loaded with a 3.6 kg weight over an area 2.5 cm by 10.2 cm. Failure occurs if either the weight falls through the sample or the flame penetrates the sample. The duration of the test is 30 minutes. The fiberglass of the instant invention provides an increased time to failure for a variety of insulated duct constructions.

1. A flame resistant fiberglass insulation having a softening point of no more than, or less than, 699° C., and an elevated glass viscosity.

2. The insulation of claim 1 wherein the softening point is between about 680 to about 699° C.

3. The insulation of claim 2 wherein the softening point is between about 685 to about 695° C.

4. The insulation of claim 1 wherein the elevated glass viscosity is between about greater than log 10 of 6.0 to about 6.3.

5. The insulation of claim 4 wherein said elevated glass viscosity is from about log 6.1 to about 6.3.

6. The insulation of claim 1 wherein the combined amount of alumina and boric oxide is between about 6.1 to about 8.5 wt. %.

7. The insulation of claim 6 wherein said combined amount of alumina and boric oxide is less than about 7 wt. %.

8. The insulation of claim 1 wherein the alkali content is about above 15 wt. %.

9. The insulation of claim 8 wherein the alkali content is in the range of between about 15 to about 16.5 wt %.

10. An insulated duct for conducting a fluid comprising a wall or walls defining a hollow interior for conducting a fluid, and a layer of insulation of claim 1 wrapped about said wall or walls.

11. The insulated duct of claim 10 wherein said wall is tubular.

12. A method of improving the flame penetration resistance of an insulated duct, the insulated duct comprising a wall or walls defining a hollow interior for conducting a fluid, and a layer of insulation wrapped about the wall or walls, the method comprising providing the insulation of claim 1.
